(19) United States
(12) Patent Application Publication
(10) Pub. No.: US 2013/0068992 A1
(43) Pub. Date: Mar. 21, 2013

(54) METHOD FOR PRODUCING RARE EARTH PERMANENT MAGNETS, AND RARE EARTH PERMANENT MAGNETS

(71) Applicants: Kazuhiro Hono, Ibaraki (JP); Tadakatsu Ohkubo, Ibaraki (JP); Hossein Sepehri Amin, Ibaraki (JP); Noriyuki Nozawa, Osaka (JP); Takeshi Nishiuchi, Osaka (JP); Satoshi Hirosawa, Osaka (JP)

(72) Inventors: Kazuhiro Hono, Ibaraki (JP); Tadakatsu Ohkubo, Ibaraki (JP); Hossein Sepehri Amin, Ibaraki (JP); Noriyuki Nozawa, Osaka (JP); Takeshi Nishiuchi, Osaka (JP); Satoshi Hirosawa, Osaka (JP)

(21) Appl. No.: 13/698,748

(22) PCT Filed: May 19, 2011
(86) PCT No.: PCT/JP2011/061488

§ 371 Date: Nov. 19, 2012

(30) Foreign Application Priority Data
May 20, 2010 (JP) 2010-116531
Jul. 30, 2010 (JP) 2010-171905

(51) Int. Cl. H01F 1/01

(52) U.S. Cl. 252/62.55

(57) ABSTRACT

An R-T-B based permanent magnet powder, which has been made by an HDDR process and which has an average crystal grain size of 0.1 μm to 1 μm and a crystal grain aspect ratio (ratio of the major axis size to the minor axis size) of 2 or less, is provided (Step (A)). R is a rare-earth element, of which at least 95 at % is Nd and/or Pr, and T is either Fe alone or Fe partially replaced with Co and/or Ni and is a transition metal element, of which at least 50 at % is Fe. Meanwhile, an R′—Cu based alloy powder, which is made up of R′ and Cu, which accounts for 2 at % to 50 at % of the alloy powder, is also provided (Step (B)). R′ is a rare-earth element, of which at least 90 at % is Nd and/or Pr but which includes neither Dy nor Tb. The R-T-B based permanent magnet powder and the R′—Cu based alloy powder are mixed together to obtain a mixed powder (Step (C)). And then the mixed powder is subjected to a heat treatment process at a temperature of 500° C. to 900° C. in either an inert ambient gas or a vacuum (Step (D)).

### TECHNICAL FIELD

The present invention relates to a method for producing a rare-earth permanent magnet and also relates to a rare-earth permanent magnet produced by that method.

### BACKGROUND ART

An R-T-B based permanent magnet (where R is a rare-earth element including Nd and/or Pr, T is either Fe alone or Fe partially replaced with Co and/or Ni, and B is boron) is a typical high-performance permanent magnet, has an R₂T₁₄B phase, which is a ternary tetragonal compound, as a main phase, and exhibits excellent magnetic properties.

As a method for producing an R-T-B based permanent magnet, known is an HDDR (hydrogenation-disproportionation-desorption-recombination) process. The “HDDR process” means a process in which hydrogenation, disproportionation, desorption and recombination are carried out in this order. And such a process is mostly adopted as a method of making a magnet powder to produce an anisotropic bonded magnet. In the known HDDR process, an ingot or powder of an R-T-B based alloy is maintained at a temperature of 500° C., to 1000° C., within an H₂ gas atmosphere or a mixture of an H₂ gas and an inert gas so as to occlude hydrogen into the ingot or the powder. After that, the desorption process is carried out at the temperature of 500° C., to 1000° C., until either a vacuum atmosphere with an H₂ pressure of 13 Pa or less or an inert ambient gas with an H₂ partial pressure of 13 Pa or less is created and then a cooling process is carried out.

In this process, the reactions typically advance in the following manner.

Specifically, as a result of a heat treatment process for producing the hydrogen occlusion, the hydrogenation and disproportionation reactions (which are collectively referred to as “HD reactions” that may be represented by the chemical reaction formula: Nd₂Fe₁₄B+2H₂→2NdH₂+12Fe+Fe₂B) advance to form a fine structure.

After the HD reactions, the desorption and recombination reactions (which are collectively referred to as “DR reactions” that may be represented by the chemical reaction formula: 2NdH₂+12Fe+Fe₂B→Nd₂Fe₁₄B+2H₂) are produced to make an alloy with very fine R₂T₁₄B crystalline phases.

In this description, a heat treatment process to produce the HD reactions will be referred to herein as an “HD process”, and a heat treatment process to produce the DR reactions will be referred to herein as a “DR process”. Also, a process in which the HD and DR processes are carried out will be collectively referred to herein as an “HDDR process”.

An R-T-B based permanent magnet powder, produced by such an HDDR process, exhibits high coercivity for powder and has magnetic anisotropy. The powder has such properties because the metallurgical structure thereof that has been subjected to the HDDR process substantially becomes an aggregate structure of crystal grains with very small sizes of 0.1 μm to 1 μm. Also, if the reaction conditions and composition are selected appropriately, the easy magnetization axes of the crystal grains will be aligned in one direction, too. If the sizes of the fine crystal grains are close to the single domain critical size of a tetragonal R₂T₁₄B based compound, then high coercivity is achieved even by the powder. The aggregate structure of those fine crystal grains of the tetragonal R₂T₁₄B based compound that has been obtained by the HDDR process will be referred to herein as a “recrystallized aggregate structure”.

A magnetic powder made by the HDDR process (which will be referred to herein as an “HDDR magnetic powder”) is normally mixed with a binder resin (which is also simply referred to as a “binder”) to make a compound, which is then either compression-molded or injection-molded under a magnetic field, thereby producing an anisotropic bonded magnet. It has also been proposed to use the HDDR magnetic powder to make a bulk magnet by increasing its density through a hot forming process, for example.

However, an R-T-B based permanent magnet made of such an HDDR magnetic powder cannot withstand sufficiently intense heat, which is a problem. That is why when used in an environment exposed to a high temperature (such as in a car), a magnet with such low thermal resistance is highly likely to cause an irreversible flux loss. For that reason, unless its thermal resistance is increased sufficiently, it is difficult to use the HDDR magnetic powder to make car parts. To increase the thermal resistance, the coercivity of the HDDR magnetic powder itself needs to be increased. Several methods for increasing the coercivity of an HDDR magnetic powder have been proposed so far.

Specifically, Patent Document No. 1 discloses a method for producing an R₂Fe₁₄B phase and forming a microcrystalline structure at the same time by subjecting a mixture of a rare-earth hydride powder, a ferroboron powder and a ferrous powder to the HDDR process. According to Patent Document No. 1, the coercivity would increase by adding Dy, Tb and Pr to the rare-earth hydride powder and Co, C, Al, Ga, Si, Cr, Ti, V and Nb to the ferrous powder, respectively.

Patent Document No. 2 proposes coating the surface of an HDDR magnetic powder with a layer of Nd, Dy, Tb or Pr, or an alloy including them. Specifically, a powder of an alloy including these elements and an element, of which the melting point T_{M} satisfies 500° C.≦T_{M}≦T_{H}+100° C. (where T_{H} is the HDDR process temperature), is provided and mixed with the HDDR magnetic powder, and then the mixture is subjected to a heat treatment process. If those elements diffuse over the surface of the HDDR magnetic powder, the coercivity increases. The heat treatment temperature T_{D} is set so as to satisfy the inequality 400° C.≦T_{D}≦T_{H}+50° C. In an example of Patent Document No. 2, an NdCo alloy or a DyCo alloy with a particular composition is used as an example of such an alloy.

According to the method disclosed in Patent Document No. 3, a powder including the element Dy, Tb, Nd or Pr or their alloy, compound or hydride is mixed with a hydride powder of an R—Fe—B based material, and the mixture is subjected to a diffusion heat treatment process and then to a desorption process. Patent Document No. 3 says that the alloy, compound or hydride preferably includes at least one of 3d and 4d transition metal elements. Also, according to their disclosure, it is particularly effective to add Fe, Co or Ni to improve the magnetic properties. In an example of Patent Document No. 3, an NdCo alloy and a DyCo alloy with particular compositions are given as examples of such alloys.

Patent Document No. 4 discloses that the magnetic properties, corrosion resistance and weather resistance can be improved by performing heat treatment and diffusion processes with a metal vapor of at least one element selected from the group consisting of Dy, Tb, Ho, Er, Tm, Gd, Nd, Sm, Pr, Ce, La, Y, Zr, Cr, Mo, V, Ga, Zn, Cu, Mg, Li, Al, Mn, Nb, and Ti deposited on a magnetic powder. Patent Document No. 4 says that a magnet with good magnetic properties can be obtained because Dy, Tb and other elements would diffuse through the grain boundary of the magnetic powder.

Patent Document No. 5 teaches coating an HDDR powder with an aluminum film and then subjecting it to a heat treatment process at a temperature of 450° C. to 600° C.

In the meantime, researches have been carried out on the grain boundary compositions of HDDR magnetic powders. Non-Patent Document No. 1 discloses that in a known HDDR magnetic powder, ferromagnetic elements (including Fe, Co and Ni) are included in higher percentages in an Nd-rich phase which is present between Nd₂Fe₁₄B type crystalline phases that are hard magnetic phases. Meanwhile, Non-Patent Document No. 2 discloses that the coercivity of an HDDR magnetic powder would express itself by pinning magnetic domain walls of a grain boundary Nd-rich phase. Furthermore, Non-Patent Document No. 3 discloses that the Nd-rich phase would have a different composition when a very small amount of Ga is added to the alloy composition from when no Ga is added and that is a factor in a significant increase in coercivity.

### CITATION LIST

### Patent Literature

Patent Document No. 1: Japanese Laid-Open Patent Publication No. 2-217406
Patent Document No. 2: Japanese Laid-Open Patent Publication No. 2000-96102
Patent Document No. 3: Japanese Laid-Open Patent Publication No. 2002-93610
Patent Document No. 4: Japanese Laid-Open Patent Publication No. 2008-69415
Patent Document No. 5: Japanese Laid-Open Patent Publication No. 2005-15918

### Non-Patent Literature

Non-Patent Document No. 1: W. F. Li et al., “Coercivity Mechanism of Hydrogenation Disproportionation Desorption Recombination Processed Nd—Fe—B Based Magnets”, Applied Physics Letters, Vol. 93, 052505 (2008)
Non-Patent Document No. 2: W. F. Li et al., “The Role of Grain Boundaries in the Coercivity of Hydrogenation Disproportionation Desorption Recombination Processed Nd—Fe—B Powders”, Journal of Applied Physics, Vol. 105, 07A706 (2009)
Non-Patent Document No. 3: H. Sepehri-Amin et al., “Effect of Ga Addition on the Microstructure and Magnetic Properties of Hydrogenation-Disproportionation-Desorption-Recombination Processed Nd—Fe—B Powder”, Acta Materialia, Vol. 58, 1309-1316 (2010)

### SUMMARY OF INVENTION

### Technical Problem

In the related art, people have tried to increase the coercivity by adding a variety of additive elements to an HDDR magnetic powder at various timings. In many cases, Dy or Tb, which is used as an additive element, is also expected to play a major role in increasing the coercivity. It is true that Dy and Tb would increase the coercivity highly effectively. However, the elements form part of rare and valuable natural resources and are very expensive. That is why there is a growing demand for a method for increasing the coercivity of an HDDR magnetic powder with the use of Dy and Tb minimized.

An object of the present invention is to provide a method for producing a rare-earth permanent magnet with the coercivity of an HDDR magnetic powder increased without adding Dy or Tb, which is an expensive element that forms part of rare and valuable natural resources, to the HDDR magnetic powder.

### Solution to Problem

A method for producing a rare-earth permanent magnet according to the present invention includes the steps of: (A) providing an R-T-B based permanent magnet powder (where R is a rare-earth element, of which at least 95 at % is Nd and/or Pr, and T is either Fe alone or Fe partially replaced with Co and/or Ni and is a transition metal element, of which at least 50 at % is Fe), which has been made by an HDDR process and which has a recrystallized aggregate structure with an average crystal grain size of 0.1 μm to 1 μm; (B) providing an R′—Cu based alloy powder, which is made up of R′ (where R′ is a rare-earth element, of which at least 90 at % is Nd and/or Pr but which includes neither Dy nor Tb) and Cu, which accounts for 2 at % to 50 at % of the alloy powder; (C) mixing the R-T-B based permanent magnet powder and the R′—Cu based alloy powder together to obtain a mixed powder; and (D) subjecting the mixed powder to a heat treatment process at a temperature of 500° C. to 900° C. in either an inert ambient gas or a vacuum.

In one preferred embodiment, the R-T-B based permanent magnet powder includes no Dy or Tb.

In another preferred embodiment, the R-T-B based permanent magnet powder has a coercivity of 1200 kA/m or more.

In another preferred embodiment, the step (B) includes the steps of: (b1) making an R′—Cu based alloy by a quenching process; and (b2) pulverizing the R′—Cu based alloy.

In another preferred embodiment, the step (D) includes keeping the mixed powder heated to a temperature of 500° C. to 900° C. for 5 to 240 minutes.

In another preferred embodiment, the method further includes, after the step (D), the step (D′) of conducting a second heat treatment process at a temperature of 450° C. to 600° C., which is equal to or lower than a heat treatment temperature of the step (D).

In another preferred embodiment, the method further includes, before the step (D), the step (E) of densifying the mixed powder by subjecting the powder to a hot forming process at a temperature of 500° C. to 900° C. and at a pressure of 20 MPa to 3000 MPa.

In another preferred embodiment, the method further includes, after the step (D), the step (E) of densifying the mixed powder by subjecting the powder to a hot forming process at a temperature of 500° C. to 900° C. and at a pressure of 20 MPa to 3000 MPa.

In another preferred embodiment, the step (D) includes densifying the mixed powder by conducting a hot forming process at a pressure of 20 MPa to 3000 MPa during the heat treatment process.

A rare-earth permanent magnet according to the present invention is produced by a method according to any of the preferred embodiments described above. The magnet is mainly comprised of R₂T₁₄B type compound phases with an average crystal grain size of 0.1 μm to 1 μm, and there is an R-rich phase which includes all of R, Fe and Cu and which has a thickness of 1 nm to 3 nm between the R₂T₁₄B type compound phases.

### Advantageous Effects of Invention

The present invention provides a high-performance R-T-B based permanent magnet, of which the coercivity has been increased significantly compared to what it was before subjected to the treatment, without wasting Dy or Tb, which is an expensive element that forms part of rare and valuable natural resources.

### BRIEF DESCRIPTION OF DRAWINGS

FIG. 1 A flowchart showing the procedure of a manufacturing process according to the present invention.

FIG. 2 Illustrates an example of a melt-quenching machine which may be used in an embodiment of the present invention.

FIG. 3 Schematically illustrates a hot pressing machine which may be used to make a rare-earth magnet as an embodiment of the present invention.

FIG. 4 Shows element mapping in an example of the present invention.

FIG. 5 (a) is a graph showing the concentration distributions of Nd, Fe, Co and B in the depth direction in the vicinity of the grain boundary of the main phase in an example of the present invention. (b) is a graph showing the concentration distribution of Cu in the depth direction in the vicinity of the grain boundary of the main phase in that example. And (c) is a graph showing the concentration distribution of Ga in the depth direction in the vicinity of the grain boundary of the main phase in that example.

FIG. 6A A cross-sectional TEM micrograph showing a portion of an HDDR magnetic powder, to which no Cu was introduced (as a comparative example), in the vicinity of the main phase grain boundary.

FIG. 6B A cross-sectional TEM micrograph showing a portion of an HDDR magnetic powder, to which Cu was introduced (as an example of the present invention), in the vicinity of the main phase grain boundary.

FIG. 7 A graph showing how the coercivity changed with the measuring temperature in an example of the present invention.

### DESCRIPTION OF EMBODIMENTS

The present inventors thought it would be effective to non-magnetize grain boundary phases in the recrystallized aggregate of an HDDR magnetic powder and cut off the magnetic coupling between fine crystal grains in order to increase the coercivity, and tried various methods for non-magnetizing those grain boundary phases by introducing a non-magnetic element into the grain boundary portions of the main phase (i.e., R₂Fe₁₄B phase) of the HDDR magnetic powder. As a result, the present inventors discovered that by mixing an alloy powder including a rare-earth metal such as Nd and/or Pr and Cu with the HDDR magnetic powder and subjecting the mixed powder to a heat treatment process under an appropriate condition, the grain boundary phases in the HDDR magnetic powder can be altered and the coercivity can be increased, thereby perfecting our invention.

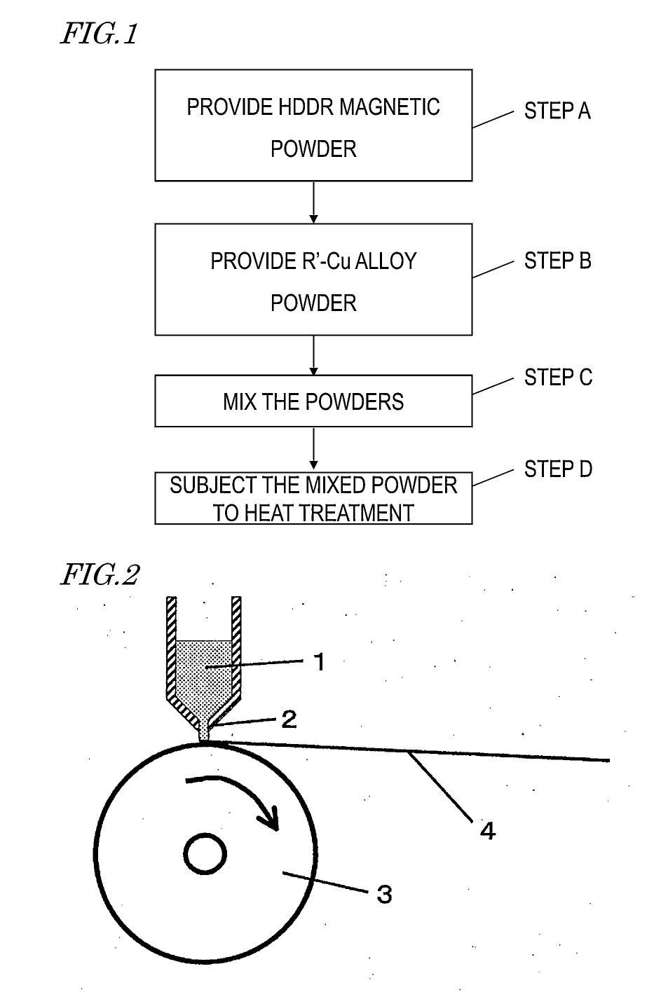

In a method for producing a rare-earth permanent magnet according to the present invention, first of all, Step A of providing an R-T-B based permanent magnet powder that has been made by an HDDR process (which will be sometimes referred to herein as an “HDDR magnetic powder”) is performed as shown in FIG. 1. In this magnet powder, R is a rare-earth element, of which at least 95 at % is Nd and/or Pr, and T is either Fe alone or Fe partially replaced with Co and/or Ni and is a transition metal element, of which at least 50 at % is Fe. Each of the powder particles that form this R-T-B based permanent magnet powder is an aggregate of fine crystal grains with an average crystal grain size of 0.1 μm to 1 μm. Those fine crystal grains have an aspect ratio (i.e., the ratio of the major axis size to the minor axis size) of two or less.

In the meantime, Step B of providing an R′—Cu based alloy powder is performed. In this alloy powder, R′ is a rare-earth element, of which at least 90 at % is Nd and/or Pr but which includes neither Dy nor Tb. The R′—Cu alloy is comprised of R′ and Cu but may include inevitable impurities. Cu accounts for 2 at % to 50 at % of the R′—Cu based alloy powder.

These process steps A and B may be carried out in an arbitrary order or may be performed separately in parallel with each other. In this description, to “provide” means not only making something with the company's own facility but also purchasing something that has been manufactured by another company.

Next, Step C of mixing the R-T-B based permanent magnet powder and the R′—Cu based alloy powder together is performed. And then Step D of subjecting the mixed powder to a heat treatment process at a temperature of 500° C. to 900° C. in either an inert ambient gas or a vacuum is performed.

According to the present invention, the R′—Cu based alloy powder to be mixed with the HDDR magnetic powder functions as a Cu supply source, and therefore, Cu can be supplied efficiently from the R′—Cu based alloy powder to the HDDR magnetic powder. It should be noted that even if simply a Cu powder is used as a Cu supply source, the coercivity could not be increased as effectively as in the present invention. Cu and Nd (and/or Pr) that have been introduced into the HDDR magnetic powder will be present in high percentages in the grain boundary phases, not inside of fine crystal grains, thus altering the grain boundary phases and increasing the coercivity as will be described in detail later. In a known HDDR magnetic powder, the grain boundary phases are roughly as thick as those of an ordinary sintered R-T-B based magnet. As described above, in a known HDDR magnetic powder, ferromagnetic elements (including Fe, Co and Ni) are included in higher percentages in an Nd-rich phase which is present between Nd₂Fe₁₄B type crystalline phases that are hard magnetic phases (see Non-Patent Document No. 2). In that known HDDR magnetic powder in which those ferromagnetic elements are included in higher percentages in an R-rich phase, the magnetic coupling between the crystal grains may not have been cut off well enough to achieve sufficient coercivity. In contrast, according to the present invention, Cu and Nd (and/or Pr) that have been supplied from the R′—Cu based alloy powder to the HDDR magnetic powder will diffuse over the grain boundary phases of the HDDR magnetic powder. As a result, as will be described later about specific examples of the present invention, non-magnetic elements Cu and Nd (and Cu, in particular) in the grain boundary phases come to have increased concentrations, which should contribute to increasing the coercivity. As will also be described later about specific examples of the present invention, the present inventors confirmed that introduction of Cu increased the thickness of the grain boundary phases in the HDDR magnetic powder. This is probably because the grain boundary phases would have come to have an even more appropriate thickness, which would have contributed to increasing the coercivity.

Nd (and/or Pr) and Cu, which are constituent elements of the R′—Cu based alloy for use in the present invention, are elements that are much cheaper and far more easily available than Dy and Tb. Also, although a lot of transition metal elements would cause a decrease in saturation magnetization when forming a solid solution in an Nd₂Fe₁₄B phase that is the main phase of the HDDR magnetic powder, Cu is an element that does not form a solid solution in the Nd₂Fe₁₄B phase so easily. That is why even if Cu is added to the HDDR magnetic powder, a decrease in its saturation magnetization can be minimized.

Hereinafter, preferred embodiments of the present invention will be described in further detail.

<R-T-B Based Permanent Magnet Powder>

The R-T-B based permanent magnet powder (i.e., the HDDR magnetic powder) for use in the present invention is obtained by pulverizing a material alloy (i.e., a starting alloy) by a known method into a material powder and then subjecting the material powder to an HDDR process. Hereinafter, the respective process steps to make the R-T-B based permanent magnet powder will be described in detail.

<Starting Alloy>

First, an R-T-B based alloy (which will be referred to herein as a “starting alloy”) including an R₂T₁₄B phase (which may be an Nd₂Fe₁₄B type compound phase) as a hard magnetic phase is provided. In the R-T-B based alloy, R is a rare-earth element, at least 95 at % of which is Nd and/or Pr. In this description, the rare-earth element R may include yttrium (Y). T is either Fe alone or Fe partially replaced with Co and/or Ni and is a transition metal element, of which at least 50 at % is Fe. B is boron and may be partially replaced with C (carbon). The R-T-B based alloy for use as a starting alloy suitably includes at least 50 vol % of R₂T₁₄B phase. To achieve an even higher remanence Bᵣ, the R-T-B based alloy more suitably includes 80 vol % or more of R₂T₁₄B phase.

Most of the rare-earth element R included in the R-T-B based alloy as the starting alloy forms R₂T₁₄B phase but some of the element R forms an R-rich phase, an R₂O₃ phase, and other phases. It is recommended that the mole fraction of the rare-earth element R account for 11 at % to about 18 at % of the overall starting alloy. The reason is as follows. Specifically, if the rare-earth element R accounted for less than 11 at %, it would be difficult to obtain fine crystal grains by the HDDR process and the effects of the present invention would not be achieved. On the other hand, if the mole fraction of the rare-earth element R were too high, then the magnetization would decrease. More specifically, if the mole fraction of the rare-earth element R exceeded 18 at %, the magnet in which the R′—Cu alloy has been diffused would be more likely to have smaller magnetization than a known high-coercivity magnet obtained by adding Dy. It is more beneficial that the mole fraction of the rare-earth element R falls within the range of 12 at % to 16 at %.

If a part (e.g., about 5 at %) of the rare-earth element R included in the starting alloy is replaced with Dy and/or Tb, the coercivity of the R-T-B based magnet powder can be further increased. That is why according to the present invention, it is not absolutely prohibited to add Dy and/or Tb as a part of the rare-earth element R. However, in order to minimize the use of Dy and/or Tb which are expensive elements that form part of rare and valuable natural resources, it is recommended that the mole fraction of Dy and/or Tb, even when added, be limited to less than 5 at % of the entire rare-earth element R (i.e., Nd and/or Pr accounts for 95 at % or more of the entire rare-earth element R). To cut down the consumption of the rare-earth elements, it is even more beneficial that the rare-earth element R includes Dy and Tb at no more than inevitable impurity levels. As described above, according to the present invention, the grain boundary phases of the HDDR magnetic powder can be altered using the R′—Cu alloy, and the coercivity can be increased as a result. For that reason, even if the amount of Dy and/or Tb added is reduced, high coercivity can still be achieved.

If the mole fraction of B included in the starting alloy were too low, an R₂T₁₇ phase and other phase that would decrease the coercivity would precipitate. But if the mole fraction of B were too high, then a B-rich phase that is a non-magnetic phase would increase to cause a decrease in remanence Bᵣ. For that reason, B included in the starting alloy suitably has a mole fraction of 5 at % to 10 at %. It would be more beneficial if the mole fraction of B falls within the range of 5.8 at % to 8 at % and even more beneficial if the mole fraction of B falls within the range of 6 at % to 7.5 at %.

T forms the balance of the alloy. As described above, T is either Fe alone or Fe partially replaced with Co and/or Ni and is a transition metal element, of which at least 50 at % is Fe. Part of T may be replaced with Co and/or Ni in order to raise the Curie temperature and/or increase the corrosion resistance. To increase the saturation magnetization of the R₂T₁₄B phase, Co is preferred to Ni. Also, considering the cost, Co suitably accounts for at most 20 at % of the entire magnet, and more suitably accounts for 8 at % or less of the alloy. Even though good magnetic properties can be achieved with no Co added at all, the magnetic properties would be more stabilized if 1 at % or more of Co is added.

To improve magnetic properties or achieve any other effect, an element such as Al, Ti, V, Cr, Ga, Nb, Mo, In, Sn, Hf, Ta, W, Cu, Si, or Zr may be added appropriately. However, if the amount of such an additive were increased, the saturation magnetization, among other things, would decrease significantly. That is why the total content of these additives is suitably at most 10 at %. Among these additives, V, Ga, In, Hf and Ta are particularly expensive, and therefore, it is recommended that any of those elements be added to 1 at % or less in view of cost considerations.

The starting alloy may be made by a known process such as a book molding process, a centrifugal process, or a strip casting process. However, to make each particle of the magnet powder exhibit good magnetic anisotropy after the HDDR process, the crystal grains in the powder particles yet to be subjected to the HDDR process need to have their easy magnetization axes aligned in one direction. Ideally, one R₂T₁₄B phase should be present in each powder particle. That is why the starting alloy in a polycrystalline state, which is not yet to be pulverized, suitably has a structure in which the main phase (i.e., the R₂T₁₄B phase) has a larger size than the particle size of the pulverized powder particles.

If a material alloy, of which the main phase (R₂T₁₄B phase) has had its size increased through the book molding process or the centrifugal process, has been made, it is difficult to remove completely α-Fe that are initial phases formed by casting. For that reason, it is recommended that the material alloy yet to be pulverized be subjected to a heat treatment in order to homogenize the structure of the material alloy. Such a heat treatment is typically carried out at a temperature of 1000° C. or more either in a vacuum or in an inert ambient gas.

<Material Powder>

Next, a material powder is made by pulverizing the material alloy (starting alloy) by a known process. In this embodiment, the starting alloy is coarsely pulverized by either a mechanical pulverization process using a jaw crusher, for example, or a hydrogen decrepitation process to obtain a coarse powder with a size of about 50 μm to about 1000 μm.

<HDDR Process>

Next, the material powder obtained by the pulverization process is subjected to an HDDR process. The temperature increasing process step to produce the HD reactions may be carried out in a hydrogen gas atmosphere with a hydrogen partial pressure of 10 kPa to 500 kPa, a mixed atmosphere of hydrogen gas and an inert gas (such as Ar or He), an inert gas atmosphere or a vacuum. If the temperature increasing process step is carried out in an inert gas atmosphere or in a vacuum, the deterioration in magnetic properties, which could be caused due to difficulty in controlling the reaction rate during the temperature increase, can be reduced.

The HD process is carried out within either a hydrogen gas atmosphere or a mixture of hydrogen gas and inert gas (such as Ar or He) with a hydrogen partial pressure of 10 kPa to 500 kPa at a temperature of 650° C. to less than 1000° C. During the HD process, the hydrogen partial pressure is more suitably 20 kPa to 200 kPa, and the process temperature is more suitably 700° C. to 900° C. The time for getting the HD process done may be 15 minutes to 10 hours, and is typically defined within the range of 30 minutes to 5 hours, for example. If in T of the R-T-B based alloy, Co accounts for 3 at % or less of the entire alloy, the ambient gas during the temperature increasing process step may have a partial pressure of hydrogen of 50 kPa or less or may be an inert gas or a vacuum. It would be more beneficial to set the partial pressure of hydrogen during the temperature increasing process step to fall within the range of 5 kPa and to 50 kPa and even more beneficial to set the partial pressure of hydrogen during the temperature increasing process step to fall within the range of 10 kPa and to 50 kPa. Then, excellent magnetic properties (a high remanence among other things) can be achieved through the HDDR process.

The HD process is followed by the DR process. The HD and DR processes may be carried out either continuously in the same system or discontinuously using two different systems.

The DR process is performed within either a vacuum or an inert gas atmosphere at a temperature of 650° C. to less than 1000° C. The process time is normally 15 minutes to 10 hours and is typically defined within the range of 30 minutes to 2 hours. Optionally, the ambient gas could naturally be controlled in a stepwise manner (e.g., the hydrogen partial pressure or the atmospheric gas pressure could be further reduced step by step).

The HDDR magnetic powder obtained by the method described above may have a coercivity H_{cJ} of 1200 kA/m or more. By using such a magnetic powder, a magnet with high coercivity and high thermal resistance can be obtained easily. And such an HDDR magnetic powder can be obtained just by adding a very small amount of Ga (e.g., on the order of approximately 0.1 to 1 at %) to the alloy composition.

<R′—Cu Alloy Powder>

The R′—Cu alloy powder for use in the present invention is an alloy powder which consists essentially of R′ and Cu (plus some inevitable impurities) and of which 2 at % to 50 at % is Cu.

R′ is a rare-earth element including at least one of Nd and Pr as its major element. Specifically, 90 at % or more of R′ is Nd and/or Pr but R′ includes Dy and Tb in no more than inevitable impurity levels. It would be more beneficial that Nd and Pr combined accounts for 97 at % or more of the entire R′.

Cu suitably accounts for 2 at % to 50 at % of the R′—Cu alloy powder and more suitably accounts for 5 at % to 40 at % of the alloy powder. The reason is as follows. Specifically, if Cu accounted for less than 2 at % of the R′—Cu alloy powder, the coercivity would increase to a certain degree but Hₖ (which is the magnitude of demagnetization field at which the magnetization value in a demagnetization curve becomes 90% of Bᵣ) would decrease too significantly to achieve sufficient thermal resistance. On the other hand, if Cu accounted for more than 50 at % of the R′—Cu alloy powder, then the coercivity would not increase sufficiently. It is even more beneficial that the Cu mole fraction in the R′—Cu alloy powder falls within the range of 10 at % to 30 at %, i.e., closer to the Nd- (or Pr-) rich range than the NdCu—Nd (or PrCu—Pr) eutectic composition in an Nd—Cu or Pr—Cu binary phase diagram.

The R′—Cu alloy powder can be obtained by a known method of making an alloy powder. To advance the reaction more uniformly when the mixture of the R′—Cu alloy powder and the HDDR magnetic powder is subjected to a heat treatment, the structure of the R′—Cu alloy should be fine and uniform. From such a point of view, it is beneficial to obtain the R′—Cu alloy by making an alloy by a melt-quenching process such as a melt spinning process or a twin wheel process and then pulverizing the melt-quenched alloy.

FIG. 2 illustrates an example of a melt quenching machine which can be used effectively in an embodiment of the present invention. Hereinafter, it will be described how to make an R′—Cu alloy using such a machine.

First of all, the material alloy is melted by being subjected to an induction heating process in an inert gas atmosphere, thereby obtaining a melt 1 of the alloy. The melt 1 is ejected through a teeming nozzle 2 with an orifice diameter of 0.5 to 2 mm onto a chill wheel 3. Since the chill wheel 3 is rotating at high velocities, the melt 1 that has contacted with the surface of the chill wheel 3 has its heat dissipated rapidly by the chill wheel and gets quenched. Then, the melt 1 is repelled by the rotating chill wheel 3 to turn into a melt quenched alloy 4 in the shape of a ribbon.

It is recommended that the chill wheel 3 be made of carbon steel, tungsten, iron, copper, molybdenum, beryllium or their alloy because these materials have good thermal conductivity and durability. During the melt-quenching process, the chill wheel 3 suitably has a surface velocity (i.e., a wheel peripheral velocity) of 1 to 50 m/s. The reason is as follows. Specifically, if the surface velocity were less than 1 m/s, the cooling rate would not be high enough to get an alloy made up of fine crystal grains as intended. In other words, the resultant structure would be made of crystal grains with too large sizes. In addition, as the melt-quenched alloy would thicken, it would be less easy to pulverize such an alloy as intended. However, if the wheel peripheral velocity exceeded 50 m/s, it could be difficult to make the alloy with good stability. In this embodiment, it is recommended that the molten alloy be cooled at a rate of 1×10²° C./s to 1×10⁹° C./s. If the alloy needs to be made by the melt spinning process, for example, a known single-wheel melt-quenching machine, of which the wheel is made of Cu, for example, may be used.

By using the R′—Cu alloy powder, the coercivity can be increased effectively through the diffusion process even when the powder has a relatively large particle size (e.g., even if powder particles with sizes of 25 μm or more account for 50 mass % or more when classified with a JIS 28801 sieve). Such a powder can be used effectively to minimize oxidation that could be caused by the R′—Cu alloy in an active state and ensure safety that would be endangered by the R′—Cu alloy in such a state. Naturally, the diffusion process may also be carried out using a finer powder so that the powder and the HDDR magnetic powder can be mixed together more uniformly.

Optionally, the R′—Cu alloy may be pulverized while being mixed with the R-T-B based permanent magnet powder (i.e., Step C to be described later). Then, the increase in the number of manufacturing processing steps can be avoided. In addition, since the R-T-B based permanent magnet powder can be further pulverized in that case, the permanent magnet powder and the R′—Cu alloy can be mixed together more uniformly. This would contribute to increasing the effect of diffusing elements from the R′—Cu alloy to the R-T-B based permanent magnet powder.

<Mixing>

The R-T-B based permanent magnet powder and the R′—Cu alloy powder may be mixed together either by a known technique using a mixer, for example, or while pulverizing the R′—Cu alloy as described above. It is recommended that the mixing ratio of the R′—Cu alloy to the R-T-B based permanent magnet powder (R′—Cu alloy powder: R-T-B based permanent magnet powder) fall within the range of 1:100 to 1:5 by mass. The reason is that if the R′—Cu alloy mixing ratio were less than 1:100, the effect of increasing the coercivity would not manifest itself. On the other hand, if the R′—Cu alloy mixing ratio were greater than 1:5, the coercivity would no longer increase but the magnetization would just decrease. It is more beneficial to set the mixing ratio to fall within the range of 1:50 to 1:5.

It is recommended that the ratio of the rare-earth elements (R+R′) to the overall composition of the mixed powder including the R-T-B based permanent magnet powder and the R′—Cu alloy powder be 12 at % to 25 at %. The reason is that if the mole fraction of the rare-earth elements (R+R′) were less than 12 at %, R-rich phases would not be produced in the grain boundary of the main phase (R₂T₁₄B phase) so much and it would be difficult to achieve high coercivity. On the other hand, if the mole fraction of the rare-earth elements (R+R′) were too high, then the magnetization would decrease. For example, if the mole fraction of the rare-earth elements (R+R′) were greater than 25 at %, then the magnetization value would be smaller than that of a known high coercivity magnet to be obtained by adding Dy. For these reasons, the mole fraction of the rare-earth elements (R+R′) suitably falls within the range of 12.5 at % to 22 at % and more suitably falls within the range of 13 at % to 20 at %.

It is recommended that the ratio of Cu to the overall composition of the mixed powder including the R-T-B based permanent magnet powder and the R′—Cu alloy powder be 0.1 at % to 5 at %. The reason is that if the ratio of Cu were less than 0.1 at %, the R-rich phase in the grain boundary of the main phase (R₂T₁₄B phase) would not have an appropriate composition and it would be difficult to achieve high coercivity. On the other hand, if the ratio of Cu were greater than 5 at %, then Nd included in the main phase (R₂T₁₄B phase) would react to Cu, and α-Fe phase and/or other phases that would affect the coercivity adversely could be produced. For these reasons, the mole fraction of Cu suitably falls within the range of 0.2 at % to 3 at %.

It should be noted that R. Nakayama and T. Takeshita disclosed in Journal of Alloys and Compounds, Vol. 193, 259 (1993) that it was very difficult to achieve excellent properties if the HDDR process was carried out after Cu with a mole fraction falling within the recommended range of the present invention (e.g., Cu=0.5 at %) had been added to the R-T-B based alloy composition.

<Diffusion Heat Treatment Process>

Next, the mixed powder is thermally treated at a temperature of 500° C. to 900° C. either in a vacuum or in an inert gas (Step D). If the heat treatment temperature were lower than 500° C., the diffusion would not advance so much as to increase the coercivity sufficiently. However, if the heat treatment temperature were higher than 900° C., then crystal grains of the R-T-B based permanent magnet powder would grow too much to avoid causing a decrease in coercivity. That is why the heat treatment temperature suitably falls within the range of 550° C. to 850° C. and more suitably falls within the range of 600° C. to 800° C. To minimize oxidation during the heat treatment process, it is recommended that the ambient gas be an inert gas atmosphere such as argon or helium gas or a vacuum. And the heat treatment may be conducted for 5 to 240 minutes. The reason is that if the heat treatment were conducted for less than 5 minutes, the diffusion would not advance sufficiently. There is no particular upper limit to the process time. However, if the process time exceeded 240 minutes, not just the productivity would decrease but also a very small amount of oxygen or water contained in the heat treatment atmosphere could produce oxidation and might deteriorate the magnetic properties.

It should be noted that if the first heat treatment process (Step D of conducting a heat treatment at a) temperature of 500° C. to 900° C. is followed by a second heat treatment process (Step D′) of conducting a heat treatment at a temperature of 450° C. to 600° C., which is equal to or lower than the heat treatment temperature of Step D, either in a vacuum or an inert gas, then the coercivity can be further increased. The heat treatment process time of the second heat treatment process is suitably 1 to 180 minutes. The reason is that if the heat treatment process time was less than one minute, the effect of the second heat treatment process could not be achieved. However, if the heat treatment process time were longer than 180 minutes, not just the productivity would decrease but also a very small amount of oxygen or water contained in the heat treatment atmosphere could produce oxidation and might deteriorate the magnetic properties.

<Hot Forming>

The magnet that has been subjected to the diffusion heat treatment process may be crushed or pulverized, mixed with a resin, and then compacted to use it as a bonded magnet. Optionally, to obtain a magnet with even better properties, the magnet may be turned into a fully densified magnet by densifying it through a hot forming process (Step E) before or after the diffusion heat treatment process.

As the hot forming process, a hot pressing process, a spark plasma sintering (SPS) process, or any other known process may be adopted. Considering the productivity, however, it would be a good measure to take to adopt an RF hot pressing process which can heat the die rapidly or an SPS process which can heat the sample rapidly by electrifying it directly.

Optionally, if the hot forming process is carried out after the easy magnetization directions of respective magnet powder particles have been aligned with a magnetic field applied, an anisotropic fully densified magnet can be obtained and a high remanence Bᵣ can be achieved. In that case, it would be efficient in terms of handling and other respects to make a green compact by compressing the magnetic powder under a magnetic field at room temperature and then subject the compact to the hot forming process.

The hot forming process may be carried out after the diffusion heat treatment process has gotten done, i.e., may be performed on a sample that has had its coercivity increased. Or the diffusion heat treatment process may also be carried out while the mixed powder including the R-T-B based magnet powder and the R′—Cu alloy powder (which will be simply referred to herein as a “mixed powder”) is being densified. Furthermore, if the mixed powder is densified through the hot forming process and then the heat treatment processing step D is carried out, then the coercivity can be increased with diffusion of the R′—Cu alloy promoted.

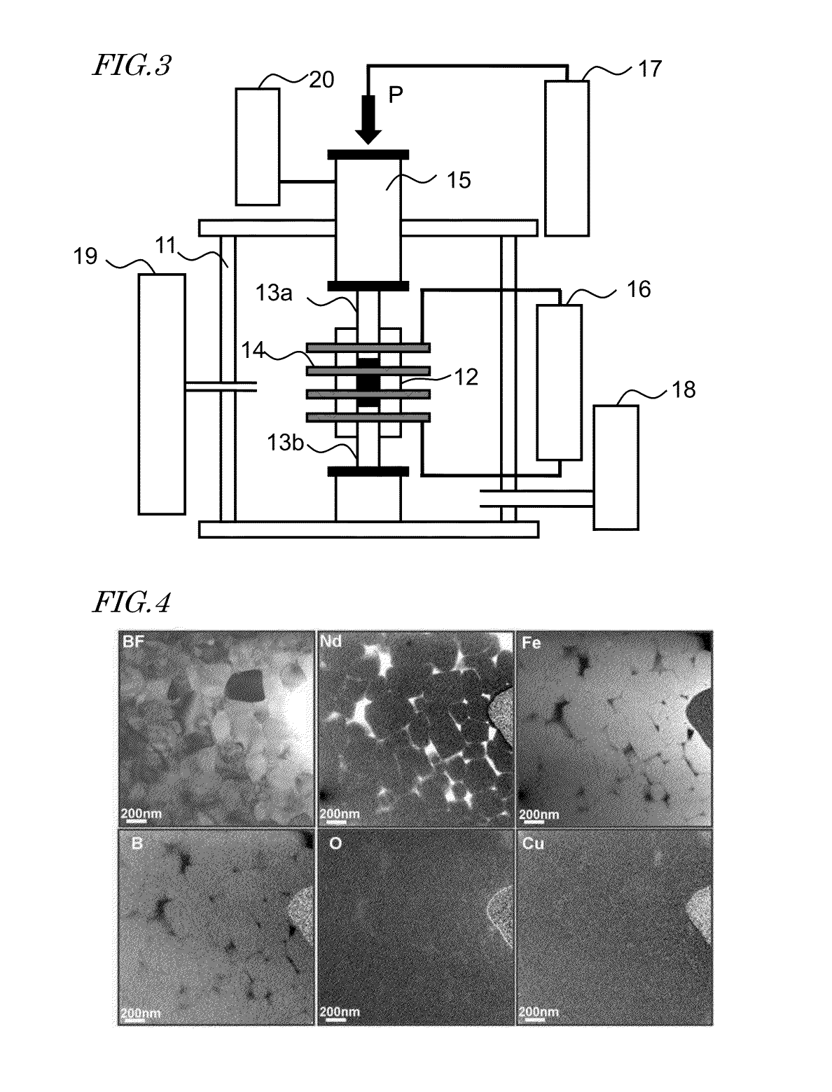

FIG. 3 schematically illustrates a hot pressing machine for use to produce a rare-earth magnet as an embodiment of the present invention. This hot pressing machine can do not only rapid heating (at a temperature increase rate of 5° C./s or more) by induction heating process but also rapid cooling (at a temperature decrease rate of −5° C./s or more) using helium gas. Using this machine, a given powder can turn into a bulk within 15 minutes.

The hot pressing machine shown in FIG. 3 is a uniaxial press machine and includes a die 12 which has a cavity that runs along its center axis to receive the mixed powder, a sample powder obtained by subjecting the R′—Cu alloy to the diffusion process, or their powder compact, an upper punch 13a and a lower punch 13b to press the mixed powder, the sample powder of the diffused R′—Cu alloy, or their powder compact, and a pressure cylinder 15 to elevate and lower the upper punch 13a. Pressure is applied from a pressure mechanism 17 to the pressure cylinder 15. Alternatively, the pressure cylinder 15 may also be arranged to elevate and lower the lower punch 13b.

The die 12 and the punches 13a and 13b are arranged in a chamber 11, which may be either evacuated by a vacuum pump 18 or filled with helium gas supplied from a helium gas supply source (such as a cylinder) 19. By filling the chamber 11 with helium gas, it is possible to prevent the powder or the powder compact from being oxidized. In addition, by supplying the helium gas, the temperature of the workpiece can be lowered rapidly (at a temperature decrease rate of −5° C./s or more).

An RF coil 14 is wound around the die 12 and the die 12 and the powder compact of the HDDR magnetic powder in the die 12 can be heated rapidly (at a temperature increase rate of 5° C./s or more) with the RF power supplied from an RF power supply 16.

The die 12 and the punches 13a and 13b may be made of a material that can withstand the highest temperature (of 500° C. to 900° C. and the highest applied pressure (of 20 MPa to 3000 MPa) within the atmospheric gas used (e.g., carbon or cemented carbide).

In an embodiment of the present invention, a mixed powder including an R-T-B based permanent magnet powder that has been made by the HDDR process and an R′—Cu powder is loaded into the die, which is then set into the hot pressing machine as shown in FIG. 3. After the chamber inside of the machine has been evacuated to 1×10⁻² Pa, the temperature is raised.

It should be noted that while the temperature is being increased, the pressure may or may not be applied.

The hot pressing machine for use in this embodiment can heat the powder or the powder compact by induction heating process to a predetermined temperature falling within the range of 500° C. to 900° C. at a temperature increase rate of 5° C./s or more.

Thereafter, when the temperature reaches a predetermined point falling within the range of 500° C. to 900° C., the temperature is maintained for a prescribed amount of time of 1 to 240 minutes with a predetermined pressure of 20 MPa to 3000 MPa applied. And then the bulk body is cooled. In this embodiment, the bulk body can be cooled with helium gas at a temperature decrease rate of −5° C./s or more.

The pressure applied during the hot pressing process is suitably 20 MPa to 3000 MPa and more suitably 50 MPa to 1000 MPa. The reason is that if the pressure were lower than 20 MPa, the densification could not be done sufficiently. However, if the pressure were higher than 3000 MPa, only a limited material could be used to make the die. In addition, if the R′—Cu alloy used had such a composition as melting at the hot pressing temperature, then the R′—Cu alloy in liquid phase would leak out so significantly as to affect the productivity. Or diffusion into the HDDR magnetic powder could be insufficient.

Likewise, if the temperature were maintained shorter than required by the hot pressing process, the R′—Cu alloy could not diffuse sufficiently. In that case, it is a good idea to diffuse the R′—Cu alloy by performing Step D after the hot pressing process. Then, Step D is suitably performed at a temperature of 500° C. to 900° C.

<Microstructure of Magnet>

A magnet obtained by the present invention has a recrystallized aggregate structure specific to an R-T-B based magnet obtained by the HDDR process, i.e., an aggregate structure which has an average crystal grain size of 0.1 μm to 1 μm and of which the crystal grains have an aspect ratio (i.e., the ratio of the major axis size to the minor axis size) of two or less. Crystal grains that form such a recrystallized aggregate structure are R₂T₁₄B type compound phases. A huge number of fine crystal grains are included in each of powder particles of the HDDR magnetic powder. The average crystal grain size and the aspect ratio of those crystal grains can be measured by observing a cross section of the magnet with a transmission electron microscope (TEM). Specifically, by capturing TEM images with a sample of the magnet that has been cut into thin flakes scanned with a focused ion beam (FIB) and by subjecting respective crystal grains in the TEM images to an image analysis, the average grain size and aspect ratio of the crystal grains can be obtained. In this case, the average grain size can be obtained by finding the equivalent circle diameters of respective crystal grains in the TEM image and by simply calculating their average. It should be noted that the major axis of a crystal grain refers herein to the longest diameter of the crystal grain as observed in its cross section and the minor axis thereof refers to the shortest diameter of that crystal grain.

Also, there are R-rich phases which include all of R, Fe and Cu and which have a thickness of 1 nm to 3 nm between the R₂T₁₄B type compound phases (grain boundary phases). The former grain boundary phases (i.e., the R-rich phases) suitably have a thickness of 1.5 nm to 3 nm. It is not quite clear what effect the additive Cu will achieve. To say the least, as disclosed in Non-Patent Documents Nos. 1 to 3, the composition and thickness of the R-rich phases would determine how easily the magnetic domain walls can move in the vicinity of the grain boundaries. The coercivity increases with Cu added probably because Cu would be included in high concentrations in the R-rich phases in the grain boundaries and affect the thickness and properties of the R-rich phases.

### EXAMPLES

Hereinafter, specific examples of the present invention and comparative examples will be described.

### Experimental Examples 1 to 6

### Making R-T-B Based Permanent Magnet Powder (Step A)>

A cast alloy with the composition Nd_{12.5}Fe_{bal}Co₈B_{6.5}Ga_{0.2} (in atomic percentages) was made, subjected to a homogenizing heat treatment process at 1110° C. for 16 hours within a low pressure argon ambient gas, pulverized, and then only powder particles with particle sizes of 300 μm or less were collected and subjected to an HDDR process. The HDDR process was carried out in a tubular furnace in the following manner. First of all, a hydrogenation-disproportionation (HD) process was performed by raising the temperature to 850° C. in an argon ambient gas, changing the atmospheres into hydrogen gas at the atmospheric pressure, and then maintaining the temperature at 850° C. for four hours. After that, the atmospheres were changed again into a low pressure argon gas at 5.33 kPa and the same temperature was maintained for 30 minutes, thereby performing a desorption-recombination (DR) process. After that, the alloy was cooled to obtain an R-T-B based permanent magnet powder. The coercivity (H_{cJ}) of the R-T-B based permanent magnet powder thus obtained was measured with a vibrating sample magnetometer (VSM) VSM-5-20 (manufactured by Toei Industry Co., Ltd.). As a result, the coercivity (H_{cJ}) was 1321 kA/m. Also, the magnet powder thus obtained was turned into thin flakes with a focused ion beam (FIB) and observed with a transmission electron microscope (TEM). The average of the equivalent circle diameters of crystal grains (e.g., 33 crystal grains observed) that were present in (a 1.8 μm×1.8 μm area of) the TEM image calculated 0.29 μm by an image analysis. Those crystal grains had almost isometric shapes with an average aspect ratio of two or less, which are typically obtained through an HDDR process.

<Making R′—Cu Based Alloy (Step B)>

Nd—Cu melt-quenched alloys with the compositions shown in the following Tables 1 through 6 were made by a melt spinning process (single wheel process) using a Cu wheel at a wheel peripheral velocity of 31.4 m/s.

<Mixing (Step C)>

The R-T-B based permanent magnet powder obtained by performing Step A and the Nd—Cu based alloy obtained by performing Step B were compounded at the mixing ratios shown in Tables 1 through 6 and mixed together while being pulverized with a mortar in a glove box, of which the atmosphere was replaced with argon gas. In the following tables, the mixing ratios are represented in weight percentages, and the Nd and Cu ratios are calculated with respect to the overall composition of the mixed powder.

<Heat Treatment (Step D)>

The mixed powder thus obtained was put into a quartz container, evacuated to less than 8×10⁻³ Pa with an infrared lamp heater QHC-E44VHT (manufactured by ULVAC-RIKO Inc.) and then had its temperature increased to the first heat treatment temperature in approximately five seconds. Subsequently, the powder was kept heated under the first heat treatment condition and then cooled. The first heat treatment condition is shown in the following Tables 1 to 6. In Experimental Examples 1 to 6, the second heat treatment was not carried out.

<Evaluation>

Each of the samples thus obtained was crushed, fixed on paraffin while being aligned under a magnetic field and then had its magnetic properties evaluated with a high magnetic field VSM. Specifically, a thermally demagnetized sample was set into a VSM machine MaglabVSM (manufactured by Oxford Instruments) and then magnetized with an external magnetic field (static magnetic field) applied to 9.5 T. After that, the magnetic field strength was decreased all the way down to −9.5 T and then the coercivity was estimated. The coercivity measured is shown on the rightmost column of Tables 1 to 6.

As shown in the following Tables 1 to 6, it was confirmed that by performing a heat treatment process under a predetermined condition with the magnet powder and the Nd—Cu alloy mixed together, the coercivity could be increased significantly.

TABLE 1
Experimental Example 1:

| | Mixing | | | | | |
|---|---|---|---|---|---|---|
| | ratio | | | | | |
| | of | | | | | |
| Nd—Cu | Nd—Cu | | | | | |
| alloy | powder | | | | | |
| compo- | to | | | | | HcJ |
| sition | HDDR | Nd | Cu | 1^{st} heat | 2^{nd} heat | (kA/ |
| (at %) | powder | (at %) | (at %) | treatment | treatment | m) |
| — | Not | 12.5 | 0 | Not | Not | 1321 |
| | mixed | | | conducted | con- | |
| Nd₈₀Cu₂₀ | 1:5 | 15.7 | 0.95 | 600° C. × 30 min | ducted | 1464 |
| | | | | 700° C. × 30 min | | 1512 |
| | | | | 750° C. × 30 min | | 1504 |
| | | | | 800° C. × 30 min | | 1504 |

TABLE 2
Experimental Example 2:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₇₀Cu₃₀ | 1:10 | 15.4 | 1.52 | 700° C. × | | 1456 |
| | | | | 30 min | | |
| | | | | 750° C. × | | 1464 |
| | | | | 30 min | | |
| | | | | 800° C. × | | 1472 |
| | | | | 30 min | | |

TABLE 3
Experimental Example 3:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₉₀Cu₁₀ | 1:10 | 16.0 | .45 | 700° C. × | | 1488 |
| | | | | 30 min | | |
| | | | | 750° C. × | | 1448 |
| | | | | 30 min | | |
| | | | | 800° C. × | | 1464 |
| | | | | 30 min | | |

TABLE 4
Experimental Example 4:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₈₀Cu₂₀ | 1:5 | 18.6 | 1.82 | 800° C. × | | 1504 |
| | 1:10 | 15.7 | 0.95 | 30 min | | 1472 |

TABLE 5
Experimental Example 5:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₇₀Cu₃₀ | 1:10 | 15.4 | 1.52 | 800° C. × | | 1472 |
| Nd₈₀Cu₂₀ | | 15.7 | 0.95 | 30 min | | 1472 |
| Nd₉₀Cu₁₀ | | 16.0 | 0.45 | | | 1464 |

TABLE 6
Experimental Example 6:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₇₀Cu₃₀ | 1:10 | 15.4 | 1.52 | 700° C. × | | 1456 |
| Nd₈₀Cu₂₀ | | 15.7 | 0.95 | 30 min | | 1464 |
| Nd₉₀Cu₁₀ | | 16.0 | 0.45 | | | 1488 |

### Experimental Example 7

### Making R-T-B Based Permanent Magnet Powder and R′—Cu Alloy and Mixing (Steps A to C

A melt-quenched alloy with the composition Nd₈₀Cu₂₀ (in atomic percentages) and an R-T-B based permanent magnet powder with the composition Nd_{12.5}Fe_{bal}Co₈B_{6.5}Ga_{0.2} (in atomic percentages) were made under the same condition as in Experimental Examples 1 through 6, compounded at the mixing ratio shown in Table 7, and then mixed together while being pulverized with a mortar in a glove box, of which the atmosphere was replaced with argon gas.

<Heat Treatment (Steps D and D′)>

The mixed powder thus obtained was put into a quartz container, evacuated to less than 8×10⁻³ Pa with an infrared lamp heater QHC-E44VHT (manufactured by ULVAC-RIKO Inc.) and then had its temperature increased to 700° C. in approximately five seconds. The temperature of the powder was maintained at 700° C. for 30 minutes, thereby conducting the first heat treatment process (Step D). Subsequently, the temperature of the powder was decreased to 550° C. in approximately five seconds and maintained at 550° C. for 60 minutes, thereby conducting the second heat treatment process (Step D′). After that, the powder was cooled. Meanwhile, another sample was obtained by subjecting the powder to the first heat treatment process under the same condition (i.e., maintained at 700° C. for 30 minutes) and cooling it immediately without subjecting it to the second heat treatment process.

<Evaluation>

Each of the samples thus obtained was crushed, fixed on paraffin while being aligned under a magnetic field and then had its magnetic properties evaluated with a high magnetic field VSM. Specifically, a thermally demagnetized sample was set into a VSM machine MaglabVSM (manufactured by Oxford Instruments) and then magnetized with an external magnetic field (static magnetic field) applied to 9.5 T. After that, the magnetic field strength was decreased all the way down to −9.5 T and then the coercivity was estimated.

As can be seen from the following Table 7, the coercivity could be further increased by performing the second heat treatment process.

TABLE 7
Experimental Example 7:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1321 |
| | | | | conducted | conducted | |
| Nd₈₀Cu₂₀ | 1:10 | 18.6 | 1.82 | 700° C. × | Not | 1512 |
| | | | | 30 min | conducted | |
| | | | | | 550° C. × | 1551 |
| | | | | | 60 min | |

### Experimental Example 8

### Making R-T-B Based Permanent Magnet Powder and R′-M Alloy and Mixing (Steps A to C

An R-T-B based permanent magnet powder with the composition Nd₁₂₃₅Fe_{bal}Co₈B_{6.5}Ga_{0.2} (in atomic percentages) was made under the same condition as in Experimental Examples 1.

In the meantime, melt-quenched alloys with an Nd-M composition (where M═Cu, Co, Ni or Mn) were made by a single wheel process at a wheel peripheral velocity of 20 m/s. The melt-quenched alloys had the compositions shown in the following Table 8. Each of the melt-quenched alloys was pulverized with a coffee mill in a chamber, of which the atmosphere was replaced with argon gas. After that, powder particles with particle sizes of 150 μm or less were collected to make an Nd-M alloy powder. Then, the R-T-B based permanent magnet powder and Nd-M alloy powder thus obtained were mixed together.

Of the powder thus obtained, 5 g of an Nd—Cu alloy powder had its particle size distribution measured with a JIS Z8801 sieve. The results are shown in the following Table 9. As can be seen from Table 9, particles with particle sizes of 25 μm or more accounted 50 mass % or more of the entire powder.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to the first heat treatment temperature shown in Table 8 in 30 minutes. Subsequently, the first heat treatment temperature was maintained for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Tables 8 and 9, it was confirmed that in an example of the present invention in which an Nd—Cu alloy was used, the coercivity could be increased significantly even when particles with as large a size as 25 μm or more were used. On the other hand, in a comparative example in which a powder of an Nd-M alloy including Co, Ni and Mn was used instead of Cu, the coercivity could not be increased sufficiently effectively.

TABLE 8
Experimental Example 8:

| Nd-M | Mixing ratio | | | | | | |
|---|---|---|---|---|---|---|---|
| alloy | of Nd-M | | | | | | |
| compo- | powder to | | | | | | |
| sition | HDDR | Nd | Cu | 1^{st} heat | 2^{nd} heat | HcJ | |
| (at %) | powder | (at %) | (at %) | treatment | treatment | (kA/m) | |
| — | Not mixed | 12.5 | 0 | Not | Not | 1326 | Reference |
| | | | | conducted | conducted | | example |
| Nd₈₀Cu₂₀ | 1:5 | 18.6 | 1.82 | 750° C. × 30 | | 1487 | Exapmle of |
| | | | | min | | | this invention |
| Nd₈₀Cu₂₀ | 1:5 | (18.7) | (0) | 700° C. × 30 | | 1335 | Comparative |
| | | | | min | | | examples |
| | | | | 750° C. × 30 | | 1365 | |
| | | | | min | | | |
| | | | | 800° C. × 30 | | 1399 | |
| | | | | min | | | |
| Nd₇₀Cu₃₀ | 1:5 | (18.1) | (0) | 700° C. × 30 | | 1334 | |
| | | | | min | | | |
| | | | | 750° C. × 30 | | 1366 | |
| | | | | min | | | |
| | | | | 800° C. × 30 | | 1401 | |
| | | | | min | | | |
| Nd₈₀Cu₂₀ | 1:5 | (18.7) | (0) | 700° C. × 30 | | 1330 | |
| | | | | min | | | |
| | | | | 750° C. × 30 | | 1329 | |
| | | | | min | | | |
| | | | | 800° C. × 30 | | 1340 | |
| | | | | min | | | |
| Nd₈₀Cu₂₀ | 1:5 | (18.7) | (0) | 700° C. × 30 | | 859 | |
| | | | | min | | | |
| | | | | 750° C. × 30 | | 1171 | |
| | | | | min | | | |
| | | | | 800° C. × 30 | | 1296 | |
| | | | | min | | | |

TABLE 9

| Particle size (μm) | Percentage (mass %) |
|---|---|
| 25 or less | 5.62 |
| 25< and ≦63 | 11.04 |
| 63< and ≦106 | 40.33 |
| 106< and ≦150 | 42.96 |
| 150< | 0.05 |

### Experimental Example 9

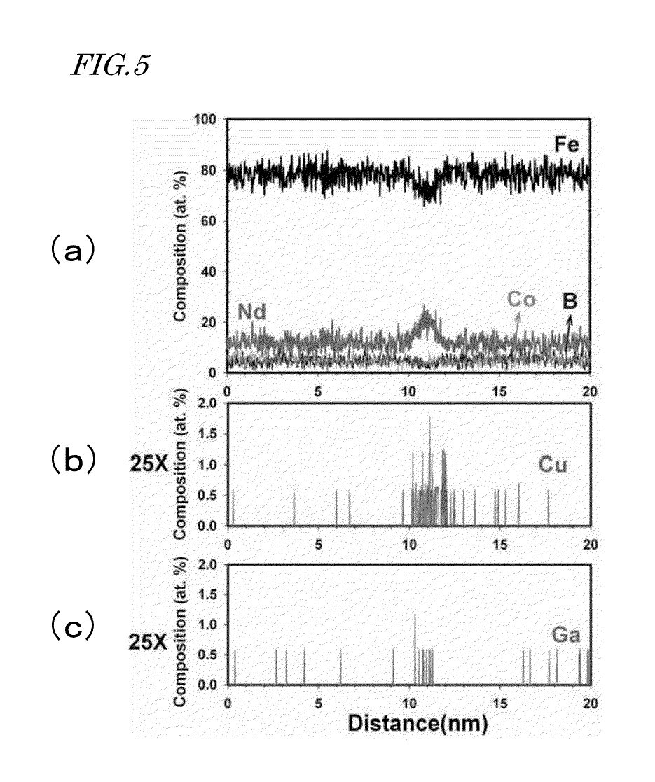

Of the samples that were obtained in Experimental Example 7, the one that had been subjected to only the first heat treatment process (at 700° C.×30 minutes) and that had an H_{cJ} of 1512 kA/m was subjected to element mapping using a transmission electron microscope (TEM) and an electron energy loss spectroscopy (EELS). FIG. 4 shows the results of the element mapping. In the vicinity of the grain boundary of this sample, an element analysis was carried out in the depth direction using a laser assisted three-dimensional atom probe. FIG. 5(a) is a graph showing the concentration distributions of Nd, Fe, Co and B in the depth direction in the vicinity of the grain boundary of the main phase. FIG. 5(b) is a graph showing the concentration distribution of Cu in the depth direction. And FIG. 5(c) is a graph showing the concentration distribution of Ga in the depth direction in the vicinity of the grain boundary of the main phase. In FIG. 5(a), a region where the Fe concentration locally decreases and the Nd concentration locally increases represents the grain boundary phase (i.e., an Nd-rich phase) and two parts that are located on the right- and left-hand sides of that region correspond to two adjacent main phase crystal grains. As can be seen from FIGS. 5(a) and 5(b), Cu was included in a high concentration in the Nd-rich phase. It was confirmed that the percentage of Cu in the main phase, which was obtained through an atom probe analysis, was as low as 0.0125 at % or less even with a statistical error taken into account. As a result, the present inventors discovered that Cu that had been introduced through diffusion was included in a high concentration in the grain boundary phase.

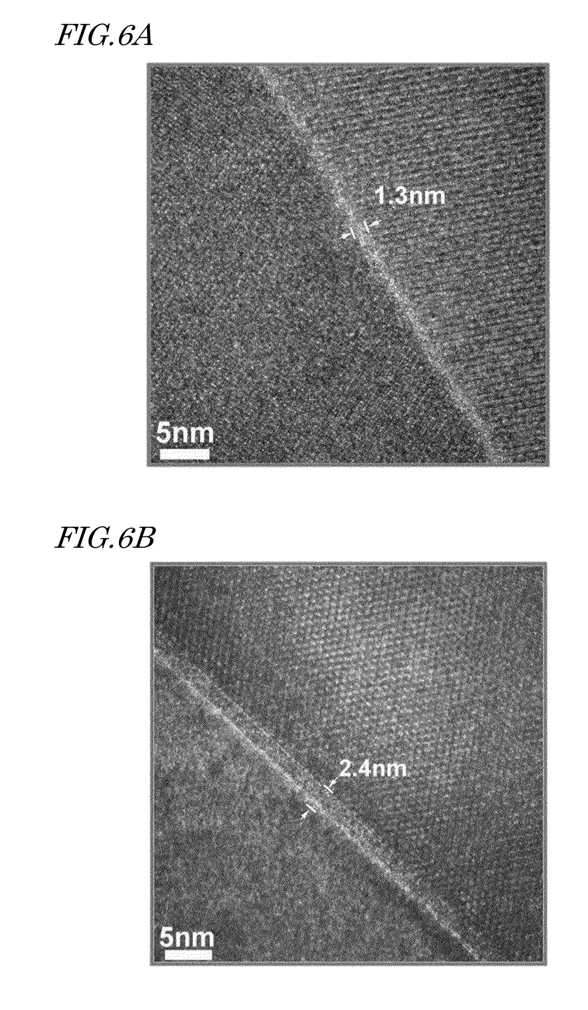

FIG. 6A is a cross-sectional TEM micrograph showing a portion of the R-T-B based permanent magnet powder, to which no Cu was introduced (as a comparative example), in the vicinity of the main phase grain boundary. And FIG. 6B is a high resolution electron micrograph (i.e., a cross-sectional TEM micrograph) showing a portion of that sample in the vicinity of the main phase grain boundary. The present inventors confirmed that with Cu introduced, the thickness of the grain boundary phase (Nd-rich phase) increased from 1.3 nm (in a comparative example) to 2.4 nm (example of the present invention).

### Experimental Example 10

### Making R-T-B Based Permanent Magnet Powder and R′—Cu Alloy and Mixing (Steps A to C)

A melt-quenched alloy powder with the composition Nd₈₀Cu₂₀ (in atomic percentages) and an R-T-B based permanent magnet powder with the composition Nd_{12.5}Fe_{bal}Co₈B_{6.5}Ga_{0.2} (in atomic percentages) were made under the same conditions as in Experimental Example 8 and then mixed together at the mixing ratios shown in the following Table 10.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to the first heat treatment temperature shown in Table 10 in 30 minutes. Subsequently, the first heat treatment temperature was maintained for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 10, it was confirmed that the coercivity could be increased when the mixing ratio of the Nd—Cu alloy powder and the R-T-B based permanent magnet powder was in the range of 1:5 to 1:80 and particularly high coercivity could be achieved at a mixing ratio of 1:5 to 1:20.

TABLE 10
Experimental Example 10:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1326 |
| | | | | conducted | conducted | |
| Nd₈₀Cu₂₀ | 1:5 | 18.6 | 1.82 | 700° C. × | | 1491 |
| | 1:10 | 15.7 | 0.95 | 30 min | | 1479 |
| | 1:20 | 14.1 | 0.49 | | | 1460 |
| | 1:40 | 13.3 | 0.25 | | | 1441 |
| | 1:80 | 12.9 | 0.12 | | | 1402 |

### Experimental Example 11

### Making R-T-B Based Permanent Magnet Powder (Step A)

A cast alloy with the composition Nd_{12.5}Fe_{bal}Co₈B_{6.5}Ga₁ (in atomic percentages) was made, subjected to a homogenizing heat treatment process at 1110° C. for 16 hours within a low pressure argon ambient gas, pulverized, and then only powder particles with particle sizes of 300 μm or less were collected and subjected to an HDDR process. The HDDR process was carried out in a tubular furnace in the following manner. First of all, a hydrogenation-disproportionation (HD) process was performed by raising the temperature to 830° C. in an argon ambient gas, changing the atmospheres into hydrogen gas at the atmospheric pressure, and then maintaining the temperature at 830° C. for two hours. After that, the atmospheres were changed again into a low pressure argon gas at 5.33 kPa and the same temperature was maintained for 30 minutes, thereby performing a desorption-recombination (DR) process. After that, the alloy was cooled to obtain an R-T-B based permanent magnet powder.

The coercivity (H_{cJ}) of the R-T-B based permanent magnet powder thus obtained was measured with a vibrating sample magnetometer (VSM) VSM-5-20 (manufactured by Toei Industry Co., Ltd). As a result, the coercivity (H_{cJ}) was 1199 kA/m. The average crystal grain size and average aspect ratio of the magnet powder thus obtained were calculated by the same methods as in Experimental Example 1, which turned out to be 0.31 μm and 2 or less, respectively.

<Making and Mixing R′—Cu Alloy (Steps B and C)>

A melt-quenched alloy powder with the composition Nd₈₀Cu₂₀ (in atomic percentages) was made under the same condition as in Experimental Example 8 and then mixed with the R-T-B based permanent magnet powder.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to the first heat treatment temperature shown in Table 11 in 30 minutes. Subsequently, the first heat treatment temperature was maintained for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 11, it was confirmed that even when an R-T-B based permanent magnet powder having a different composition from any of Experimental Examples 1 to 10 was used, the coercivity could also be increased effectively.

TABLE 11
Experimental Example 11:

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1199 |
| | | | | conducted | conducted | |
| Nd₈₀Cu₂₀ | 1:5 | 18.6 | 1.82 | 700° C. × | | 1311 |
| | | | | 30 min | | |
| | | | | 750° C. × | | 1302 |
| | | | | 30 min | | |
| | | | | 800° C. × | | 1287 |
| | | | | 30 min | | |

### Experimental Example 12

### Making R-T-B Based Permanent Magnet Powder and R′—Cu Alloy and Mixing (Steps A to C)

A melt-quenched alloy powder with the composition Nd₈₀Cu₂₀ (in atomic percentages) and an R-T-B based permanent magnet powder with the composition Nd_{12.5}Fe_{bal}Co₈B_{6.5}Ga_{0.2} (in atomic percentages) and with an H_{cJ} of 1323 kA/m were made under the same conditions as in Experimental Example 8 and then mixed together at the mixing ratios shown in the following Table 12.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to the first heat treatment temperature shown in Table 12 in 30 minutes. Subsequently, the first heat treatment temperature was maintained for the period of time shown in the following Table 12 and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 12, it was confirmed that the coercivity could be increased when the first heat treatment temperature was within the range of 500° C. to 900° C. On the other hand, the coercivity somewhat decreased at a heat treatment period of 450° C. and decreased significantly at 930° C.

TABLE 12
Experimental Example 12:

| Nd-Cu | Mixing ratio | | | | | | |
|---|---|---|---|---|---|---|---|
| alloy | of Nd-Cu | | | | | | |
| compo- | powder to | | | | | | |
| sition | HDDR | Nd | Cu | 1^{st} heat | 2^{nd} heat | HcJ | |
| (at %) | powder | (at %) | (at %) | treatment | treatment | (kA/m) | |
| — | Not mixed | 12.5 | 0 | Not | Not | 1323 | Reference |
| | | | | conducted | conducted | | example |
| Nd₈₀Cu₂₀ | 1:5 | 18.6 | 1.82 | 500° C. × | | 1429 | Exapmle of |
| | | | | 30 min | | | this invention |
| | | | | 550° C. × | | 1434 | |
| | | | | 30 min | | | |
| | | | | 600° C. × | | 1411 | |
| | | | | 5 min | | | |
| | | | | 600° C. × | | 1433 | |
| | | | | 30 min | | | |
| | | | | 600° C. × | | 1513 | |
| | | | | 240 min | | | |
| | | | | 800° C. × | | 1466 | |
| | | | | 1 min | | | |
| | | | | 800° C. × | | 1465 | |
| | | | | 5 min | | | |
| | | | | 800° C. × | | 1481 | |
| | | | | 15 min | | | |
| | | | | 800° C. × | | 1470 | |
| | | | | 30 min | | | |
| | | | | 800° C. × | | 1476 | |
| | | | | 60 min | | | |
| | | | | 800° C. × | | 1438 | |
| | | | | 240 min | | | |
| | | | | 850° C. × | | 1433 | |
| | | | | 30 min | | | |
| | | | | 900° C. × | | 1479 | |
| | | | | 5 min | | | |
| | 1:20 | 14.1 | 0.49 | 600° C. × | | 1464 | Examples of |
| | | | | 240 min | | | this invention |
| | | | | 800° C. × | | 1440 | |
| | | | | 240 min | | | |
| | | | | 850° C. × | | 1436 | |
| | | | | 30 min | | | |
| | 1:5 | 18.6 | 1.82 | 450° C. × | | 1174 | Comparative |
| | | | | 30 min | | | examples |
| | | | | 930° C. × | | 1221 | |
| | | | | 5 min | | | |
| | | | | 930° C. × | | 128 | |
| | | | | 30 min | | | |

### Experimental Example 13

### Making R-T-B Based Permanent Magnet Powder and R′—Cu Alloy and Mixing (Steps A to C)

A melt-quenched Nd—Cu alloy powder with the composition shown in the following Table 13 and an R-T-B based permanent magnet powder with the composition Nd_{12.5}Fe_{bal}Co₈B_{6.5}Ga_{0.2} (in atomic percentages) and with an H_{cJ} of 1321 kA/m were made under the same conditions as in Experimental Example 8 and then mixed together at the mixing ratios shown in Table 13.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to 800° C. in 30 minutes. Subsequently, the first heat treatment was conducted with the temperature maintained at 800° C. for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

TABLE 13
Experimental Example 13:

| Nd-Cu | Mixing ratio | | | | | | | |
|---|---|---|---|---|---|---|---|---|
| alloy | of Nd-Cu | | | | | | | |
| compo- | powder to | | | | | | | |
| sition | HDDR | Nd | Cu | 1^{st} heat | 2^{nd} heat | HcJ | Hk | |
| (at %) | powder | (at %) | (at %) | treatment | treatment | (kA/m) | (KA/m) | |
| Nd₄₅Cu₅₅ | 1:5 | 16.2 | 6.27 | 800° C. × 30 | Not | 751 | 321 | Comparative |
| | | | | min | conducted | | | examples |
| Nd₅₅Cu₄₅ | | 17.0 | 4.79 | | | 1447 | 433 | Example of |
| Nd₆₀Cu₄₀ | | 17.4 | 4.12 | | | 1510 | 422 | this |
| Nd₈₀Cu₂₀ | | 18.7 | 1.82 | | | 1503 | 458 | invention |
| Nd₉₀Cu₁₀ | | 19.2 | 0.86 | | | 1501 | 445 | |
| Nd₉₅Cu₅ | | 19.4 | 0.42 | | | 1506 | 445 | |
| Nd₉₈Cu₂ | | 19.6 | 0.17 | | | 1491 | 420 | |
| Nd | | 19.7 | 0 | | | 1489 | 387 | Comparative |
| | | | | | | | | example |

As shown in Table 13, the alloy with the composition Nd₄₅Cu₅₅ had much smaller coercivity than the starting magnetic powder. It can also be seen that although the coercivity (H_{cJ}) could be increased by diffusing the metal Nd, the Hₖ value was less than 400 kA/m (i.e., approximately 5 kOe). On the other hand, when an alloy with an Nd—Cu composition as an example of the present invention was diffused, a high H_{cJ} and an Hₖ of 400 kA/m or more were achieved. Particularly when an alloy with the composition Nd₉₅Cu₅, Nd₉₀Cu₁₀ or Nd₈₀Cu₂₀ was used, a high Hₖ could be achieved. The significant difference in coercivity between Nd₅₅Cu₄₅ and Nd₄₅Cu₅₅ would have something to do with the fact that although an NdCu phase and an Nd phase coexist in the Nd-rich range with respect to the Nd₅₀Cu₅₀ composition in the equilibrium diagram, an NdCu phase and an NdCu₂ phase coexist in the Nd-poor range.

### Experimental Example 14

### Making R-T-B Based Permanent Magnet Powder (Step A)

A cast alloy with the composition Nd_{12.5}Fe_{bal}Co₃B_{6.2}Ga_{0.2} (in atomic percentages) was made, subjected to a homogenizing heat treatment process at 1110° C. for 16 hours within a low pressure argon ambient gas, pulverized, and then only powder particles with particle sizes of 300 μm or less were collected and subjected to an HDDR process. The HDDR process was carried out in a tubular furnace in the following manner. First of all, a hydrogenation-disproportionation (HD) process was performed by raising the temperature to 820° C. in an argon ambient gas, changing the atmospheres into hydrogen gas at the atmospheric pressure, and then maintaining the temperature at 820° C. for two hours. After that, the atmospheres were changed again into a low pressure argon gas at 5.33 kPa and the same temperature was maintained for one hour, thereby performing a desorption-recombination (DR) process. After that, the alloy was cooled to obtain an R-T-B based permanent magnet powder.

The coercivity (H_{cJ}) of the R-T-B based permanent magnet powder thus obtained was measured with a vibrating sample magnetometer (VSM) VSM-5-20 (manufactured by Toei Industry Co., Ltd). As a result, the coercivity (H_{cJ}) was 1191 kA/m. The average crystal grain size and average aspect ratio of the magnet powder thus obtained were calculated by the same methods as in Experimental Example 1, which turned out to be 0.33 μm and 2 or less, respectively.

<Making and Mixing R′—Cu Alloy (Steps B and C)>

A melt-quenched alloy powder with the composition Nd₈₀Cu (in atomic percentages) was made under the same condition as in Experimental Example 8 and then mixed with the R-T-B based permanent magnet powder.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to the first heat treatment temperature shown in Table 14 in 30 minutes. Subsequently, the first heat treatment temperature was maintained for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 14, it was confirmed that even when an R-T-B based permanent magnet powder having a different composition from any of Experimental Examples 1 to was used, the coercivity could also be increased effectively.

TABLE 14

| | Mixing | | | | | |
|---|---|---|---|---|---|---|
| Nd-Cu | ratio | | | | | |
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1191 |
| | | | | conducted | conducted | |
| Nd₈₀Cu₂₀ | 1:5 | 18.7 | 1.82 | 700° C. × | | 1378 |
| | | | | 30 min | | |
| | | | | 750° C. × | | 1400 |
| | | | | 30 min | | |
| | | | | 800° C. × | | 1431 |
| | | | | 30 min | | |

### Experimental Example 15

### Making R-T-B Based Permanent Magnet Powder (Step A)

A cast alloy with the composition Nd₁₅Fe_{bal}Co₈B_{6.5}Ga_{0.2} (in atomic percentages) was made, subjected to a homogenizing heat treatment process at 1110° C. for 16 hours within a low pressure argon ambient gas, pulverized, and then only powder particles with particle sizes of 300 μm or less were collected and subjected to an HDDR process. The HDDR process was carried out in a tubular furnace in the following manner. First of all, a hydrogenation-disproportionation (HD) process was performed by raising the temperature to 830° C. in an argon ambient gas, changing the atmospheres into hydrogen gas at the atmospheric pressure, and then maintaining the temperature at 830° C. for three hours. After that, the atmospheres were changed again into a low pressure argon gas at 5.33 kPa and the same temperature was maintained for one hour, thereby performing a desorption-recombination (DR) process. After that, the alloy was cooled to obtain an R-T-B based permanent magnet powder.

The coercivity (H_{cJ}) of the R-T-B based permanent magnet powder thus obtained was measured with a vibrating sample magnetometer (VSM) VSM-5-20 (manufactured by Toei Industry Co., Ltd). As a result, the coercivity (H_{cJ}) was 1319 kA/m. The average crystal grain size and average aspect ratio of the magnet powder thus obtained were calculated by the same methods as in Experimental Example 1, which turned out to be 0.37 μm and 2 or less, respectively.

<Making and Mixing R′—Cu Alloy (Steps B and C)>

A melt-quenched alloy powder with the composition Nd₈₀Cu (in atomic percentages) was made under the same condition as in Experimental Example 8 and then mixed with the R-T-B based permanent magnet powder.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to 800° C. in 30 minutes. Subsequently, the first heat treatment process was carried out with the temperature maintained at 800° C. for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 15, it was confirmed that even when an R-T-B based permanent magnet powder having a different composition from any of Experimental Examples 1 to 14 was used, the coercivity could also be increased effectively.

TABLE 15

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 1319 |
| | | | | conducted | conducted | |
| Nd₈₀Cu₂₀ | 1:5 | 21.1 | 1.88 | 800° C. × | | 1433 |
| | | | | 30 min | | |

### Experimental Example 16

### Making R-T-B Based Permanent Magnet Powder (Step A)>

A cast alloy with the composition Nd_{13.5}Fe_{bal}Co₈B_{6.5} (in atomic percentages) was made, subjected to a homogenizing heat treatment process at 1110° C. for 16 hours within a low pressure argon ambient gas, pulverized, and then only powder particles with particle sizes of 300 μm or less were collected and subjected to an HDDR process. The HDDR process was carried out in a tubular furnace in the following manner. First of all, a hydrogenation-disproportionation (HD) process was performed by raising the temperature to 850° C. in an argon ambient gas, changing the atmospheres into hydrogen gas at the atmospheric pressure, and then maintaining the temperature at 850° C. for three hours. After that, the atmospheres were changed again into a low pressure argon gas at 5.33 kPa and the same temperature was maintained for one hour, thereby performing a desorption-recombination (DR) process. After that, the alloy was cooled to obtain an R-T-B based permanent magnet powder.

The coercivity (H_{cJ}) of the R-T-B based permanent magnet powder thus obtained was measured with a vibrating sample magnetometer (VSM) VSM-5-20 (manufactured by Toei Industry Co., Ltd). As a result, the coercivity (H_{cJ}) was 896 kA/m. The average crystal grain size and average aspect ratio of the magnet powder thus obtained were calculated by the same methods as in Experimental Example 1, which turned out to be 0.33 μm and 2 or less, respectively.

<Making and Mixing R′—Cu Alloy (Steps B and C)>

A melt-quenched alloy powder with the composition Nd₈₀Cu (in atomic percentages) was made under the same condition as in Experimental Example 8 and then mixed with the R-T-B based permanent magnet powder.

<Heat Treatment (Step D)>

The mixed powder thus obtained was wrapped in Nb foil and then loaded into a high vacuum heat treatment system that used a tungsten heater as a heat source. The chamber was evacuated to less than 6×10⁻³ Pa and then had its temperature increased to 800° C. in 30 minutes. Subsequently, the first heat treatment process was carried out with the temperature maintained at 800° C. for 30 minutes and then the powder was cooled with argon gas introduced.

<Evaluation>

Each of the samples thus obtained was crushed to a size of 300 μm or less, fixed on paraffin while being aligned under a magnetic field, magnetized with a pulse magnetic field of 4.8 MA/m, and then had its magnetic properties evaluated with VSM-5-20 (manufactured by Toei Industry Co., Ltd).

As can be seen from Table 16, it was confirmed that even when an R-T-B based permanent magnet powder having a different composition from any of Experimental Examples 1 to was used, the coercivity could also be increased effectively.

TABLE 16

| Nd-Cu | Mixing ratio | | | | | |
|---|---|---|---|---|---|---|
| alloy | of Nd-Cu | | | | | |
| compo- | powder to | | | | | |
| sition | HDDR | Nd | Cu | 1^{st} heat | 2^{nd} heat | HcJ |
| (at %) | powder | (at %) | (at %) | treatment | treatment | (kA/m) |
| — | Not mixed | 12.5 | 0 | Not | Not | 896 |
| | | | | conducted | conducted | |
| Nd₈₀Cu₂₀ | 1:5 | 19.6 | 1.85 | 800° C. × | | 1324 |
| | | | | 30 min | | |

### Experimental Example 17

### Making R-T-B Based Permanent Magnet Powder and R′—Cu Alloy and Mixing (Steps A to C)

A melt-quenched alloy powder with the composition Nd₈₀Cu₂₀ (in atomic percentages) and an R-T-B based permanent magnet powder with the composition Nd_{12.5}Fe_{bal}Co₈B_{6.5}Ga_{0.2} (in atomic percentages) and with an H_{cJ} of 1323 kA/m were made under the same conditions as in Experimental Example 8 and then mixed together at the mixing ratios shown in Table 17.

<Hot Pressing (Step E)>

3.85 g of the mixed powder thus obtained was loaded into a die of a non-magnetic cemented carbide with an inside diameter of 8.3 mm and then hot pressed with the RF hot pressing machine shown in FIG. 3, thereby obtaining a circular cylindrical bulk body. Specifically, the die was heated by induction heating process to the temperature shown in Table 17 at a temperature increase rate of 11° C./sec with the pressure shown in Table 17 applied thereto in a vacuum of 1×10⁻² Pa or less, kept heated to that temperature for two minutes, and immediately cooled with helium gas introduced into the chamber.

<Heat Treatment (Step D)>

The bulk body thus obtained was wrapped in Nb foil, and then loaded into a quartz tube, where the bulk body was subjected to the first heat treatment process under the condition shown in Table 17 within an argon ambient gas. After that, the quartz tube itself, still including the bulk body, was rapid cooled.

<Evaluation>

The upper and lower surfaces of the circular cylindrical sample thus obtained were machined with a surface grinder with the oxidized phase removed from the side surfaces of the sample, magnetized with a pulse magnetic field of 4.8 MA/m, and then had its magnetic properties evaluated with a BH tracer MTR-1412 (manufactured by METRON Inc).

As can be seen from Table 18, by mixing the Nd—Cu alloy, turning it into a bulk through the hot pressing process and then conducting the first heat treatment process, a bulk magnet, of which the coercivity was higher than that of the starting magnetic powder, could be obtained. On the other hand, it was confirmed that if only the R-T-B based permanent magnet powder was hot pressed and thermally treated without being mixed with the Nd—Cu alloy, the coercivity turned out to be equal to or smaller than that of the starting magnetic powder.

TABLE 17

| | Nd-Cu | Mixing ratio | | | | |
|---|---|---|---|---|---|---|
| | alloy | of Nd-Cu | | | | |
| | compo- | powder to | | | Hot | |
| | sition | HDDR | Nd | Cu | pressing | 1^{st} heat |
| No. | (at %) | powder | (at %) | (at %) | condition | treatment |
| Ref. | — | Not mixed | 12.5 | 0 | Not | Not |
| | | | | | conducted | conducted |
| 1 | Nd₈₀Cu₂₀ | 1:10 | 15.7 | 0.95 | 200 MPa, | 550° C. × |
| | | | | | 800° C. × | 60 min |
| | | | | | 2 min | |
| 2 | | | | | 200 MPa, | 800° C. × |
| | | | | | 800° C. × | 30 min |
| | | | | | 2 min | |
| 3 | | | | | 586 MPa, | 800° C. × |
| | | | | | 800° C. × | 30 min |
| | | | | | 2 min | |
| 4 | — | Not mixed | 12.5 | 0 | 200 MPa, | 550° C. × |
| | | | | | 800° C. × | 60 min |
| | | | | | 2 min | |
| 5 | | | | | 200 MPa, | 800° C. × |
| | | | | | 800° C. × | 30 min |
| | | | | | 2 min | |
| 6 | | | | | 586 MPa, | 800° C. × |
| | | | | | 800° C. × | 30 min |
| | | | | | 2 min | |

TABLE 18

| No. | Density (g/cm³) | HcJ (kA/m) | |
|---|---|---|---|
| Ref. | — | 1323 | Reference example |
| 1 | 7.56 | 1411 | Examples of this invention |
| 2 | 7.56 | 1427 | |
| 3 | 7.61 | 1423 | |
| 4 | 7.60 | 1176 | Comparative examples |
| 5 | 7.62 | 1160 | |
| 6 | 7.63 | 1208 | |

### Experimental Example 18

### Making R-T-B Based Permanent Magnet Powder and R′—Cu Alloy and Mixing (Steps A to C)

A melt-quenched alloy with the composition Nd₈₀Cu₂₀ (in atomic percentages) and an R-T-B based permanent magnet powder with the composition Nd_{12.5}Fe_{bal}Co₈B_{6.5}Ga_{0.2} (in atomic percentages) were made under the same conditions as in Experimental Examples 1 to 7, compounded so that the R′—Cu based alloy and the R-T-B based permanent magnet powder are included at a mass ratio of one to five, and then mixed together while being pulverized with a mortar in a glove box, of which the ambient gas was replaced with argon gas.

<Heat Treatment>

The mixed powder thus obtained was put into a quartz container, and evacuated to less than 8×10⁻³ Pa with an infrared lamp heater QHC-E44VHT (manufactured by ULVAC-RIKO Inc.). After that, the first heat treatment process (Step D) was carried out by increasing the temperature to 650° C. in approximately one minute and to 700° C. in approximately three minutes and then maintaining the temperature at 700° C. for 30 minutes. Then, the powder was cooled to room temperature in approximately 30 minutes. Subsequently, the second heat treatment process (Step D′) was carried out by increasing the temperature to 500° C. in approximately one minute and to 550° C. in approximately three minutes and then maintaining the temperature at 550° C. for 60 minutes. Thereafter, the powder was cooled.

<Evaluation>

Each of the samples thus obtained was crushed, fixed while being aligned under a magnetic field and then had the temperature dependence of its magnetic properties evaluated with a high magnetic field VSM. Specifically, the magnetically aligned sample was set into a VSM machine MPMS SQUID VSM (manufactured by Quantum Design Japan), heated to each of sensing temperatures of 300 K (approximately 27° C.) to 400 K (approximately 127° C.), and then magnetized with an external magnetic field applied to 7 T. After that, the magnetic field strength was decreased all the way down to −7 T and then the coercivity was estimated at each of those temperatures.

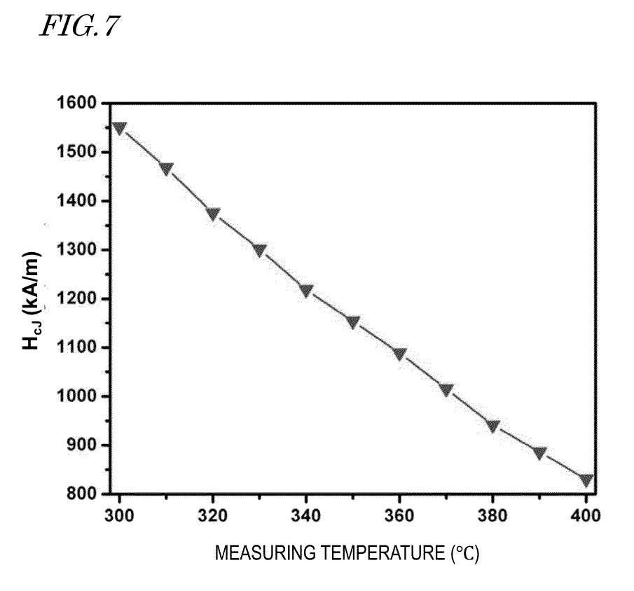

FIG. 7 shows how the coercivity changed with the measuring temperature. On the gradient of this curve, the temperature coefficient of the coercivity calculated −0.4%/(t, which is smaller than −0.55%/° C. that is the temperature coefficient of the coercivity of a retailed sintered Nd—Fe—B based magnet with the same coercivity. Consequently, it was confirmed that the magnet of the present invention had better temperature dependence of coercivity.

### Experimental Example 19

Making R-T-B Based Permanent Magnet Powder and R′—Cu Alloy and Mixing (Steps A to C)

An R-T-B based permanent magnet powder with the composition Nd_{13.5}Fe_{bal}Co₈B_{6.5} (in atomic percentages) and with an H_{cJ} of 896 kA/m and a melt-quenched alloy with the composition Nd₈₀Cu₂₀ (in atomic percentages) were made under the same conditions as in Experimental Example 16, compounded so that the R′—Cu based alloy and the R-T-B based permanent magnet powder are included at a mass ratio of one to ten, and then mixed together while being pulverized with a mortar in a glove box, of which the ambient gas was replaced with argon gas.

<Heat Treatment (Step D)>

4 g of the mixed powder thus obtained was aligned with an external magnetic field of 0.8 T with a pressure of 140 MPa applied parallel to the alignment direction, thereby making a green compact. Next, the green compact was loaded into a die of a non-magnetic cemented carbide with an inside diameter of 8 mm and then hot pressed with the RF hot pressing machine shown in FIG. 3 while being subjected to the first heat treatment process, thereby obtaining a circular cylindrical bulk body. Specifically, the die was heated to 580° C. at a temperature increase rate of 11° C./sec in a vacuum of 1×10⁻² Pa or less, kept heated to 580° C. for two minutes with a pressure of 586 MPa applied so as to be densified and thermally treated at the same time, and then rapidly cooled with helium gas introduced into the chamber immediately.

<Evaluation>

The upper and lower surfaces of the circular cylindrical sample thus obtained were machined with a surface grinder with the oxidized phase removed from the side surfaces of the sample, magnetized with a pulse magnetic field of 4.8 MA/m, and then had its magnetic properties evaluated with a BH tracer MTR-1412 (manufactured by METRON Inc.).

The sample thus obtained had as high a coercivity (H_{cJ}) as 1309 kA/m.

### INDUSTRIAL APPLICABILITY

According to the present invention, a high-performance permanent magnet can be produced without wasting Dy or Tb, which is an element that forms part of rare and valuable natural resources.

### REFERENCE SIGNS LIST

1 melt of alloy
2 teeming nozzle
3 chill wheel
4 melt-quenched alloy ribbon
11 chamber
12 die
13a upper punch
13b lower punch
14 RF coil
15 pressure cylinder
16 RF power supply
17 pressure mechanism
18 vacuum pump
19 helium gas supply source

1. A method for producing a rare-earth permanent magnet, the method comprising the steps of:
(A) providing an R-T-B based permanent magnet powder (where R is a rare-earth element, of which at least 95 at % is Nd and/or Pr, and T is either Fe alone or Fe partially replaced with Co and/or Ni and is a transition metal element, of which at least 50 at % is Fe), which has been made by an HDDR process and which has a recrystallized aggregate structure with an average crystal grain size of 0.1 μm to 1 μm;
(B) providing an R′—Cu based alloy powder, which is made up of R′ (where R′ is a rare-earth element, of which at least 90 at % is Nd and/or Pr but which includes neither Dy nor Tb) and Cu, which accounts for 2 at % to 50 at % of the alloy powder;
(C) mixing the R-T-B based permanent magnet powder and the R′—Cu based alloy powder together to obtain a mixed powder; and
(D) subjecting the mixed powder to a heat treatment process at a temperature of 500° C. to 900° C. in either an inert ambient gas or a vacuum.

2. The method of claim 1, wherein the R-T-B based permanent magnet powder includes no Dy or Tb.

3. The method of claim 1, wherein the R-T-B based permanent magnet powder has a coercivity of 1200 kA/m or more.

4. The method of claim 1, wherein the step (B) includes the steps of:
(b1) making an R′—Cu based alloy by a quenching process; and
(b2) pulverizing the R′—Cu based alloy.

5. The method of claim 1, wherein the step (D) includes keeping the mixed powder heated to a temperature of 500° C. to 900° C. for 5 to 240 minutes.

6. The method of claim 5, further comprising, after the step (D), the step (D′) of conducting a second heat treatment process at a temperature of 450° C. to 600° C., which is equal to or lower than a heat treatment temperature of the step (D).

7. The method of claim 1, further comprising, before the step (D), the step (E) of densifying the mixed powder by subjecting the powder to a hot forming process at a temperature of 500° C. to 900° C. and at a pressure of 20 MPa to 3000 MPa.

8. The method of claim 1, further comprising, after the step (D), the step (E) of densifying the mixed powder by subjecting the powder to a hot forming process at a temperature of 500° C. to 900° C. and at a pressure of 20 MPa to 3000 MPa.

9. The method of claim 1, wherein the step (D) includes densifying the mixed powder by conducting a hot forming process at a pressure of 20 MPa to 3000 MPa during the heat treatment process.

10. A rare-earth permanent magnet produced by the method of claim 1,
wherein the magnet is mainly comprised of RT14B type compound phases with an average crystal grain size of 0.1 μm to 1 μm, and
wherein there is an R-rich phase which includes all of R, Fe and Cu and which has a thickness of 1 nm to 3 nm between the R₂T₁₄B type compound phases.
